(19) United States
(12) Patent Application Publication
(10) Pub. No.: US 2012/0168538 A1
(43) Pub. Date: Jul. 5, 2012

(54) Spin Annular Slit Spray Nozzle and Spray Apparatus Thereof

(76) Inventor: Tiefu Han, Xiamen (CN)

(21) Appl. No.: 13/395,150

(22) PCT Filed: Oct. 16, 2009
(86) PCT No.: PCT/CN09/74480

§ 371 Date: Mar. 9, 2012

(51) Int. Cl. A62C 31/02

(52) U.S. Cl. 239/589

(57) ABSTRACT

A spin annular slit spray nozzle includes: a core seat, a spin core, and a spin annular slit orifice. Said core seat has a core chamber, an inlet and an outlet communicated with the core chamber are provided on the core seat; the inlet of the core seat is communicated with a pressurized flow source; said spin core is limited in the core chamber which is concentric with the spin core and may rotate with respect to each other; spin-actuating channels are formed on the spin core or on the core chamber wall. Due to the spin power from the spin-actuating channels, the spin core and the core chamber can rotate with respect to each other; a core head on the outer end of the spin core extends into the outlet of the core chamber; the spin annular slit orifice is form between the core head and the outlet end of the core chamber; the cross-section of the orifice is nearly a circular ring; the fineness and the flow of the pressurized mist of the spray nozzle are controlled respectively through adjusting the gap and diameter of the ring, and the distribution of the drop sizes is thus uniformly finer. A spray apparatus comprises said spin annular slit spray nozzle and the sprinkler body communicated with the spray nozzle core seat.

### TECHNICAL FIELD

The invention relates to a spray apparatus, and more particularly to a spin annular slit spray nozzle with ability of fineness control and a spray apparatus comprising the same, which belongs to the technical field of fire control and spraying.

### BACKGROUND

The spray head is an essential element for spraying, and the spraying quality has an essential influence on water mist fire suppression, wet dust removal, spray drying, and combustion performance of liquid fuel.

The spray head has small round orifice(s) in general. At present, some spray heads with small round holes depend on the spin flow generated by the spin flow cores of rotors to spray; for example, Chinese Patent Application Nos. 01253101.4 and 200380103103.0 disclose a type of pressure spray heads with small round holes. The spray heads of this type cannot properly control spray fineness and the orifices are very small and cannot be made large. When other spray nozzle parameters are unchanged, the size of the spray drops can rapidly increase along with the increase of the diameter of the orifice, so that the spray quality deteriorates, which means the round orifice need to become smaller to spray finer mist. However, the spray flow is in direct proportion to the square of the hole diameter; at the same pressure, the smaller the hole is, the smaller the flow is, so that the spray concentration and density cannot meet requirements. Chinese Patent Application No. 200410012959.3 discloses a double-layer nozzle, which can increase spray flow and overcome the defect of small orifices. However, in order to uniformly and finely spray, the gap between the annular slits of the fixed double-layer nozzle must be made small and uniform. Such a fixed double-layer nozzle requires high mutual concentricity and high neutrality, is difficult to manufacture and is easily blocked. Thus, the filtering difficulty and manufacturing and application cost of the system are increased.

The existing spray head with a rotary disk depends on a thin liquid film formed thereon by the centrifugal force of high-speed rotation to perform centrifugal spray. Although the rotary centrifugal spray head can finely spray, it has a hollow zone and cannot spray further. The periphery of the rotary disk of such a spray head is often provided with an annular air spray opening, such as a spray head shown in Chinese Patent Application No. 200410036938.5. However, the annular air spray opening is not used for spraying liquid but for spraying air so as to break the liquid film rotated out by the rotary disk. The spray head belongs to gas-liquid two-phase atomization, requires additional air source, and has a complicated structure.

Many spray processes require high-quality spray, which require fine spray of the spray drops sprayed by the spray apparatus, and also require dense spray, high flow, good directivity of spray space distribution or wide space distribution, and good dispersivity. Some of the aims of fine spray are for flash evaporation. The evaporation rate is nearly in inverse proportion to the square of the spray drop diameter, namely the evaporation rate is accelerated about 100 times when the diameter is reduced to 1/10. Therefore, in the field of spray drying, water mist total flooding application for fire control, and oil spray combustion, rapid and massive evaporation is a key for increasing working efficiency. Thus, it is necessary to develop a high-flow superfine spray nozzle. However, the spray fineness of the existing nozzle is not uniform, the spray drop diameter is difficult to control, and particularly, the existing single nozzle cannot synchronously perform fine spray and high-flow spray. In addition, the water mist spray head for fire control is specially required to have a small volume, simple structure, and reliable operation. The existing spray head for fire control hardly meets the aforementioned comprehensive requirements, and particularly, it is more difficult to resolve the contradiction between the spray flow and fine spray.

### SUMMARY

In view of the above-described problems, it is one aim of the invention to provide a spin annular slit spray nozzle capable of spraying uniformly and finely and capable of spraying at high flow rate, and to give several spin annular slit spray nozzles with different structures for application at different occasions.

Another aim of the invention is to provide a spray nozzle and a control method capable of simultaneously and easily controlling spray drops and spray flow, so as to resolve the difficulty of taking account of both spray flow and fine spray.

To use and benefit from the advantages of the spin annular slit spray nozzle, and to expand and enhance spray space dispersivity, directivity, and other spray performance, the invention further gives a spray apparatus combined with the spin annular slit spray nozzle, so as to meet various spray process requirements, and strengthen the specific spray performance of the spray apparatus such as quick superfine spray evaporation, etc.

The aim of the invention is also to provide a nozzle structure which is clog resistant and capable of self-cleaning, and the structure can be made into a self-closing dust-proof spray nozzle and spray apparatus so as to improve the quality and reliability of fine spray, and can be used for spraying single-fluid water mist and multi-phase flow superfine spray.

The purpose of the invention is achieved by the following technical schemes.

The invention relates to a spin annular slit spray nozzle, comprising a core seat, a spin core, and a spin annular slit orifice; wherein the core seat has a core chamber, an inlet and an outlet communicated with the core chamber are provided on the core seat, and the inlet of the core seat is communicated with a pressurized flow source; the spin core is limited and sheathed in the core chamber which is concentric with the spin core and rotates with respect to each other, spin-actuating channels are formed on the spin core or on the core chamber wall; the spin power from the spin-actuating channels make the spin core and the core chamber rotate with respect to each other, a core head on the outer end of the spin core extends into the outlet of the core chamber, the spin annular slit orifice is formed between the core head and the outlet end of the core chamber, the cross-section of the orifice is nearly a circular ring, the gap of the ring mainly decides the spray fineness, the diameter of the ring mainly decides the spray flow, and the fineness and flow required by the pressure spray of the spray nozzle can be obtained by respectively setting the gap and the diameter of the ring.

The axial shape of the spin annular slit orifice is a short and round or conical tube-shaped annular slit, and an inlet gap of the annular slit orifice is not less than an outlet gap thereof. The annular slit orifice close to the outlet can be provided with a spray opening with the minimum annular slit gap.

The spin core is in the shape of a stepped column; the peripheral surface of the spin core is provided an oblique or spiral tooth/groove-shaped spin-actuating channel, and the front end of the spin core is contracted into a small conical or small cylindrical core column head; the core column head penetrates into the outlet hole of the core seat and forms the spin annular slit orifice together with the outlet hole of the core seat, and the front end ring surface of the spin core, used as a rotary thrust limit surface, mutually slides with the front end wall of the core chamber.

The output end ring surface of the spin core is uniformly distributed with at least two sections of wedge oblique surfaces or wedge ring surfaces; the opening angle of the wedge surfaces is 2 to 15°; the opening of the wedge surface faces the rotation direction of the spin core, and the wedge surfaces produce buoyance to the spin core during rotation so as to reduce friction.

The spin core is provided with a center hole communicated with the inlet of the core chamber and extended to the outlet end of the spin core; the tube wall of the outlet end of the spin core is uniformly distributed with radial small holes and/or oblique small holes; the center hole of the spin core supplies pressure to the annular slit orifice through each small hole, to help the spin core suspend in the center and reduce friction.

The peripheral surface of the core column head or the outlet hole wall of the core chamber is distributed with a short section of annular dense textures to enhance the turbulence fluctuation and fine spray effects of the rotary liquid film at the spray opening.

The annular slit spray opening of the spray nozzle is sealed by the outer end of the spin core to prevent dust, and the inner end of the spin core is provided with elastic element(s) capable of internally pulling or externally pushing the spin core, so that the conical surface or cambered surface of the outer end of the spin core leans against the outlet hole wall of the core chamber; the elastic element is an elastic washer/gasket or spring whose weak elastic force does not disturb the hydraulic pressure spin spray of the annular slit spray opening and is favorable to atomization.

The core seat is of combined type, a concentric subsidiary core seat is arranged in the core chamber of the core seat; the disk-shaped peripheral wall of the subsidiary core seat is provided with a spin flow groove/tooth-shaped spin-actuating channel; the spin core is positioned between the core chamber and the subsidiary core seat and uses a top center hole of the subsidiary core seat as a bearing hole to perform rotation and partial axial limit; the column head of the spin core concentrically penetrates into the contracted conical outlet hole of the core seat to form a reversed conical tube-shaped annular slit orifice.

The spin core is of complex type; the spin core is provided with an outer core chamber and an inner core chamber which are communicated with the inlet of the core seat and concentric with each other; the outer core chamber wall is provided with outer spin flow passage(s); the inner core chamber is positioned at the center of the outer core chamber, and provided with an inner core element; the inner spray hole wall formed by contracting the inner core chamber inserts in the center of the outlet hole of the outer core chamber to form a spin annular slit orifice with a central spray hole, and the core seat or the core seat cover and the outer core chamber wall are provided with spin flow passage(s) used as spin-actuating channel(s) of the spin core.

The spin-actuating channel(s) is arranged on the spin core and/or the core seat; the spin-actuating channels of the spin core can be oblique or spiral grooves/teeth/leaves; the spin-actuating channel(s) of the core seat is arranged on the wall of the core chamber or the close cover of the core seat and is a spin flow groove/hole.

The spray fineness and flow are respectively controlled by the spin annular slit spray nozzle; the average spray drop diameter is controlled within the range of narrow size: if the average drop diameter required by spray fineness is T, suppose the hole diameter at the minimum gap of the annular slit spray opening is D and the diameter of the core column head at the minimum gap is d, (D−d)≦T×K, and K is a correlation coefficient of 1-3; the spray flow can be estimated by the formula Q=fΔPπDδ³/12 μL to determine the value of D and d, wherein f represents a coefficient (0.3<f<1) related to the spin flow rate of the spin annular slit and the eccentricity of the annular slit, ΔP represents a pressure difference, μ represents viscosity, D represents a hole diameter, L represents a hole length of annular slit, and δ represents an average slit width.

A spray apparatus of the invention comprises a spray head body and a spray nozzle; the spray nozzle is arranged on the spray head body; the spray head body is provided with a spray head body chamber; its inlet end is connected with a pressurized flow source, and its outlet end is communicated with the spray nozzle; the spray nozzle comprises a spin annular slit spray nozzle.

A spray apparatus of the invention: the spray head body is provided with a spray head body chamber of which each end is provided a central through hole, the spray head body is rotatably and fixedly sheathed on a steeped inlet tube connecting a pressurized flow source by its central through holes; a rotary sealing element is arranged between the spray head body and the inlet tube, and the wall of the inlet tube is provided with a hole/groove communicated with the spray head body chamber; the sealing head is used for sealing a lower through hole of the spray head body chamber and performing rotary thrust positioning for the spray head body, and the spray nozzle is arranged in the sealing head; the periphery of the spray head body is provided with a truncated cone or polyhedral cone body overlapped with a cross body, and the spray nozzles arranged on four side surfaces of the cross body opposite to the rotation direction produce equidirectional torque; each spray nozzle arranged on the spray head body is communicated with the spray head body chamber, comprising the spin annular slit spray nozzle.

A spray apparatus of the invention, comprises: a joint, a spray head body, a core seat, spin core(s), and a spray head cover; the joint connected with a pressurized flow source is in threaded connection with an upper part of the spray head body; the spray head body is provided with a spin annular slit spray nozzle group comprising a core seat and at least three spin cores; at least three spin core chambers are arranged in the core seat; each spin core chamber is communicated with the joint inlet of the spray head body; each spin core chamber is rotatably and fixedly sheathed with a spin core to form a spin annular slit spray nozzle, and the outlets of all spray nozzles are gathered at the outlet of the core seat to spray; alternately, the outlet of the core seat is additionally provided with a Venturi tube-shaped spray head cover and the peripheral wall at the outlet of the core seat is provided with multiple suction holes; each suction hole is communicated with a mixing chamber between the outlet of the core seat and the spray head cover; the sprayed mist of each spray nozzle is mixed with air by the mixing chamber and foamily sprayed by the spray head cover.

A spray apparatus of the invention comprises a spray head body, a core seat, and spin core(s). The core seat is rotatably arranged in the spray head body chamber; the spray head body chamber is provided with spin flow passage(s); the core seat is driven to rotate by the spin flow of the passage(s); the outlet end of the peripheral surface at the outlet of the core seat penetrates into the outlet hole of the spray head body chamber to form the spin large annular slit spray nozzle; the core seat is further provided with a spray nozzle comprising a spray nozzle with a spin core, namely a composite spin annular slit spray head is formed; the spray head body chamber is communicated with a pressurized flow source and each spray nozzle.

The technical problems solved by and advantages of the invention are summarized below:

1. Aiming at overcoming the defect of the existing mist spray head and solving the technical problem that the mutual contradictions between increasing spray head hole diameter and flow and increasing atomization degree are irreconcilable, the invention provides the technical scheme of using spin annular slit to spray. The diameter of such spin annular slit can be made large and the gap can be made very small. Thus, the sprayed mist is uniform and fine and the flow area and the spray flow are large, thereby solving the technical problem that it is difficult to take account of increasing spray flow and increasing atomization degree. The existing nozzle with a small round spray hole has the defect that the diameter of the small round spray hole must be small enough to ensure good atomization, so that its spray flow is greatly limited. However, the flow area of the annular slit spray opening is much larger than that of the spray opening with a small round hole having the same gap, the flow is nearly in direct proportion to the flow area. Thus, under the same gap and pressure difference condition, the spray flow of the annular slit spray opening is much higher than that of the spray opening with a small round hole. In addition, the annular slit gap for deciding spray fineness and the hole diameter for deciding flow can be respectively set independently as required. Thus, the spray fineness may be not controlled by flow, namely the annular slit and spray drop size can be small, while the annular slit hole diameter and flow can be large.

2. The mist sprayed by the spin annular slit orifice has the obvious advantage of easier superfine spray than that sprayed by the existing orifice. The flow in the annular slit close to the movable round wall surface, and the flow close to the fixed round wall surface and the middle layer have different velocity gradient because of pressure and rotation, to form turbulence of high turbulence intensity with multi-direction components at different speed, so that the turbulence kinetic energy causing the liquid drops to be crushed for the second time after causing the liquid film jet to be smashed and divided is greatly increased, thereby accelerating superfine spray. The existing annular liquid film jet is atomized mainly depending on crushing caused by the fluctuation produced by friction disturbance between the outlet liquid ring and the air, while the spin annular slit orifice is provided with atomization factors for rotary centrifugal force growing film and high turbulence intensity fluctuation in addition to annular liquid film crushing mechanism, thereby greatly increasing its superfine spray capacity.

3. The spin annular slit orifice of the invention has the advantages of fine spray, easy control of liquid drop size, and uniform distribution as compared to the existing small round spray orifice. The spray drop size of the existing small round spray orifice is difficult to control and the spray liquid drop size is not uniform; the invention uses the spin small gap of annular slit to greatly increase the once atomization uniformity of the spray opening, and controls the spray liquid drop size and distribution by setting the annular slit gap.

4. The invention has the obvious advantage of being clog resistant. The existing fixed annular slit orifice is easy to be clogged because of small fixed gap, and the annular slit is in the rotation state when the spin annular slit orifice sprays. The core column head is moved relatively to the outlet hole wall of the core chamber, and has the functions of aligning during rotation, thereby preventing deviation and automatically cleaning obstructions. Therefore, even if the annular slit gap is very small, the spin annular slit spray opening is difficult to be blocked.

5. The spin annular slit spray nozzle has the advantage of good dust-proof property. The nozzle structure can easily be made into dust-proof closed type, namely the spray opening is externally closed usually, so that it has good dust-proof property. Even if the spray nozzle structure is not made into the dust-proof closed type, the spin annular slit spray nozzle can prevent dust in general because the exposed gap of the spin annular slit spray nozzle is much smaller than that of the spray nozzle with a round hole of the same section area, which is favorable to dust prevention.

6. The invention further has the obvious advantages of having a diverse structure and large size of the spin slit spray nozzle and the spray apparatus, thereby providing appropriate diverse spray equipment for different places. The time required for liquid drop evaporation is nearly in direct proportion to drop diameter square, so fine spray at high flow rate means spray evaporation rate is accelerated at large scale and square level. Therefore, when being used in the occasions of water mist fire control, spray drying, spray combustion and the like where spray flash evaporation is required, the invention can obviously increase gasification speed and working efficiency.

The invention will further be described in detail in accordance with the figures and the specific embodiments.

### BRIEF DESCRIPTION OF FIGURES

FIG. 1-1 is a structure diagram of a spin core spray nozzle with a hollow column P1;

FIG. 1-1A is a K view of FIG. 1-1;

FIG. 1-2 is a structure diagram of a spin core spray nozzle with a solid column P2;

FIG. 1-2A is a sectional view of FIG. 1-2 along a 0-0 line;

FIG. 1-3 is a structure diagram of a multi-spin core spray nozzle with a shared core seat P3;

FIG. 1-4 is a structure diagram of a spray nozzle with a combined core seat P4;

FIG. 1-5 is a structure diagram of a spray nozzle with a composite spin core P5;

FIG. 1-6 is a structure diagram of a dust-proof spray nozzle with a conical core column head P6;

FIG. 1-7 is a structure diagram of a dust-proof spray nozzle with an arc core column head P7;

FIG. 1-7A is a sectional view of FIG. 1-7 along a T-T line;

FIG. 2-1 is a structure diagram of an elevation half section of a total space spray head;

FIG. 2-1A is a sectional view of FIG. 2-1 in a C-C direction;

FIG. 2-2 is a top view of FIG. 2-1 with local section; and

FIG. 3 is a structure diagram of a spray gun/spray head.

### DETAILED DESCRIPTION

### 1. Spin Annular Slit Spray Nozzle of the Invention.

### Embodiment 1

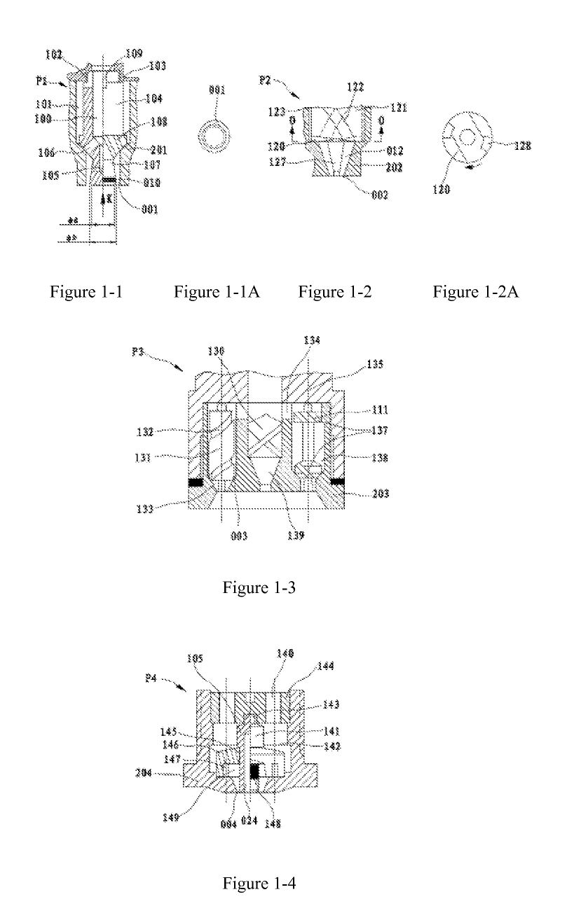

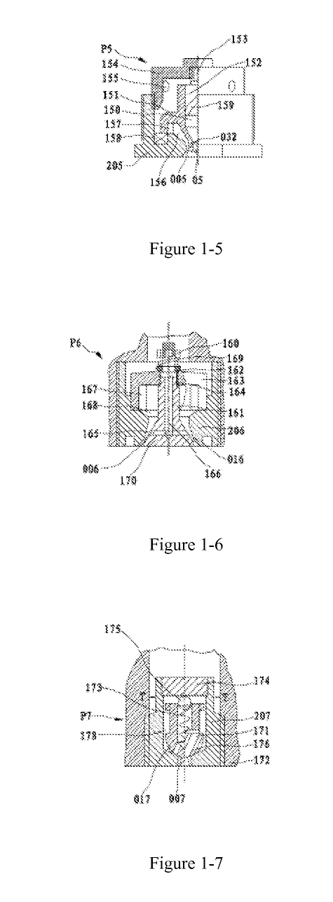

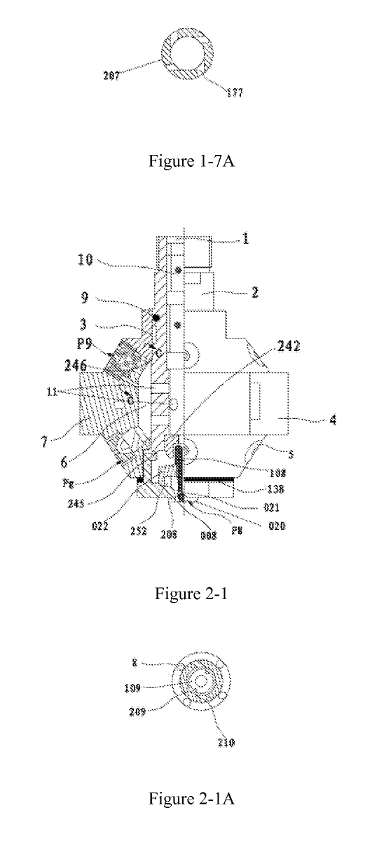

As shown in FIG. 1-1, a spin annular slit spray nozzle pl comprises a core seat 201, a spin core 104, a spin annular slit orifice 001, and a core seat cover 103. A core chamber 101 is arranged in the core seat 201. The core seat 201 is provided with an inlet and an outlet communicated with the core chamber 101, and the inlet of the core seat 201 is communicated with a pressurized flow source. The stepped cylindrical spin core 104 of which both ends are small and the middle is large employs the round hole 104 of the core chamber of the core seat and the round hole 102 of the core seat cover 103 to limit bearings at both ends and the three are concentric, and the spin core 104 is rotatably arranged in the stepped round hole core chamber 101 in a floating mode; the large column end of the spin core is contracted to a core column head 107 with a conical ring surface and a small column or small conical column, and the conical ring surface of the spin core 104 leans against the step in the contracted hole of the core chamber 101 to perform axial thrust positioning to the spin core 104; the periphery of the core column head 107 is provided with a smooth surface, the core column head 107 is positioned in the central round spray hole at the outlet of the core chamber 101 to form the annular slit orifice 010; the inlet gap of the annular slit orifice is larger than the outlet gap, and the approximate value of the outlet gap is (D−d)/2. The spin core 104 is provided with a center hole 100; the ring surface of the core column head 107 is provided with eccentric inclined holes 106 uniformly distributed; the conical ring surface is provided with a chute 108; the eccentric inclined holes 106 and the chute 108 are used as spin-actuating channels so that the spin core 104 is rotated, and then the spin annular slit spray nozzle is formed to be used for pressure spray. The small column or the small conical column of the core column head 107 is uniformly and symmetrically distributed with at least two pairs of small holes 105; both the eccentric inclined holes 106 and the small holes 105 are communicated with the center hole 100, so that the spin core is aligned with the core seat 201 and the friction between the spin core and the core seat 201 is reduced. In this embodiment, the outlet section periphery of the core column head 107 can also be provided with a section of annular dense textures 010, as shown in FIG. 1-1A, so that the outlet of the annular slit orifice is formed into an inner round annular slit spray opening 001 with dense textures, or a short section of core with annular dense textures is arranged on the outlet hole wall of the core chamber, so that the turbulence fluctuation of the rotary liquid film at the spray opening and fine spray can be enhanced.

The axial shape of the spin annular slit orifice is short and round or conical tube-shaped annular slit, and the annular slit orifice close to the outlet can be provided with a spray opening with the minimum annular slit gap.

### Embodiment 2

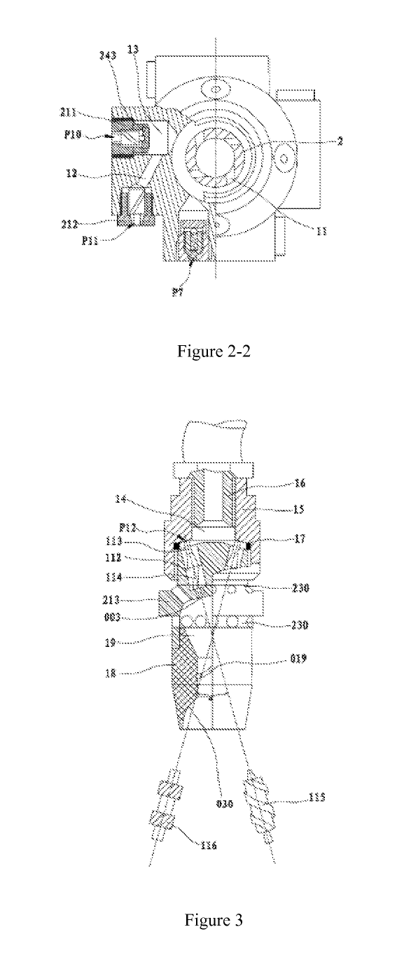

FIG. 1-2 shows a spin core spray nozzle p2 with a solid column. The center of the core seat 202 is provided with a core chamber 123; a spin core 121 capable of floating and rotating is arranged in the round hole of the core chamber; the round hole of the core chamber is used for limiting the rotation of the spin core and concentric with the spin core. The front end of the outer-ring large column section of the spin core 121 is contracted into a small cylindrical or small conical core column head 127. The core column head 127 is positioned in the reversed conical spray hole at the outlet of the core chamber to form an annular slit orifice 012. The inlet gap of the annular slit orifice 012 is larger than its outlet gap, and the outlet of the annular slit orifice 012 is an annular slit spray opening 002. The outlet of the guide groove 122 is arranged in the end ring surface 128 connecting the large column with the core column head 127 (as shown in FIG. 1-2A) and communicated with the annular slit orifice 012. The end ring surface 128 leans against the round ring step outlet of contracted hole of the core chamber 123 to axially position the spin core 121. The end ring surface 128 of the spin core 121 is uniformly and symmetrically distributed with wedge oblique surfaces 120. The opening angle of the oblique surfaces is 2 to 15°, and the opening of the oblique surfaces faces the rotation direction of the spin core 121. The periphery of the spin core 121 is provided with chute(s) or spiral groove(s) 122 which is used as a guide groove and used for providing rotation power. When the spin core 121 rotates, the oblique surfaces 120 or the ring section of oblique surfaces 120 can produce antifriction suspension force and perform pressure spray from the spin annular slit spray opening 002.

### Embodiment 3

FIG. 1-3 shows a multi-spin core spray nozzle with a shared core seat P3, comprising: a seat body 135, a core seat 203, and spin cores 131, 130 and 111. The core seat 203 is in screwed connection with the seat body 135; the core seat 203 is provided with at least three peripheral spin core chambers 133,138 and a central spin core chamber 139, and the stepped cylindrical spin cores 131, 111 are rotatably sheathed in the spin core chambers 133, 138. In the embodiment, the stepped cylindrical spin core 131 is in a stepped column shape whose both ends are small and the middle is provided with annular shoulders; the middle peripheral surface of the spin core 131 is provided with spiral tooth (teeth) or groove(s) 132 used as spin-actuating channels; the front end of the spin core 131 is contracted into a cylindrical core column head, and the core column head is inserted into the outlet of the spin core chamber 133 to form the annular slit orifice of which the inner annular slit gap is larger than the outer annular slit gap and its spray opening 003; the stepped cylindrical spin core 111 is in a stepped column shape of which both ends are small and the middle is provided with two sections of circular shoulders; the two sections of circular peripheral surfaces of the spin core 111 are respectively provided with a spiral groove 137 used as spin-actuating channels; the front end of the spin core 111 is contracted into a cylindrical core column head; the core column head is inserted into the outlet of the spin core cavity 138, to form the annular slit orifice whose inner annular slit gap is larger than the outer annular slit gap and its annular slit spray opening 004. Atomization core of other structure, such as fixed swirl vane 130, can be sheathed in the spin core chamber 139. The inner end surface penetrating into the seat body 135 in the core seat 203 is provided with guide grooves 134 communicated with the inlet of the seat body 135. The number of the guide grooves is equal to that of the spin core chambers and the guide grooves are uniformly distributed by radiating from the center. Each guide groove is communicated with a hole of each spin core chamber. All spin core chamber arranged on the periphery of the core seat can use spin cores of the same shape. Spin cores of different shapes are used in this embodiment, only indicating that various structures can be used.

### Embodiment 4

FIG. 1-4 shows a spray nozzle with a combined core seat p4, comprising: a short screw-shaped core seat 204, wherein a disk-shaped subsidiary core seat 146 and a spin core 105 are arranged in the hollow chamber 142. The inlet of the core chamber is provided with a sealing cover 144. The periphery of the sealing cover 144 is provided with guide through hole(s) 140; the bottom of the sealing cover 144 is provided with central blind hole(s), and a spin core tail column 143 is built in to limit rotary bearing(s) and upward stopping. The column core axle 145 of the spin core 105 uses the center hole of the disk-shaped subsidiary core seat 146 as a rotary bearing hole and limits downward stopping. The ring wall of the disk-shaped subsidiary core seat 146 is provided with at least two tangential spin flow through grooves 147, and the ring wall is concentrically supported on the bottom wall of the core seat 204 and forms a spin flow chamber 149 together with the contracted conical hole of the core seat 204. The surface of the spin core column in the spin flow chamber 149 is provided with a section of twill or knurling 148; the spin core 105 is provided with central blind hole(s) without pressure 024 so as to reduce the quality of the spin core. The spin core column head concentrically penetrates into the contracted conical outlet hole of the core seat 204, to form the reversed conical tube-shaped annular slit orifice and its spray opening 004. Fluid with pressure enters the core chamber 142 from the guide through hole 140 and then enters the spin flow chamber 149 after being rotated in the spin flow grooves 147, and drives the spin core 105 to rotate in a floating mode, so that the pressure fluid is rotatably extruded and sprayed from the small spin annular slit orifice of the large outlet of the inner outlet.

### Embodiment 5

FIG. 1-5 shows a spray nozzle with a composite spin core p5, comprising a core seat cover 154, a core seat 205, a spin core 151, an inner core element 152, and a bearing 158. The core seat cover 154 is in threaded connection with the core seat 205; a closed core seat chamber is formed between the core seat cover 154 and the core seat 205, and the side wall of the core seat cover 154 is provided with tangential or oblique through hole(s) 155 used for providing spin flow into the core seat chamber. The spin core 151 is a composite element. The spin core is provided with an outer core chamber and an inner core chamber which are communicated with the core seat inlet and the core seat chamber and concentric with the chamber. A conical inner core chamber 150 is arranged at the center of the circular outer core chamber 156 of the spin core 151. The inner core element 152 is fixedly inserted into an upper part of the inner core chamber 150; the inner core element 152 is provided with spiral groove(s) 159; the upper end of the inner core element 152 is provided with a tail column 153, and the center hole in the inner top surface of the core seat 154 is used as a rotary bearing hole by the tail column 153. The outer end of the ring chamber wall of the spin core 151 is provided with bearing 158, and the bearing 158 is fixed in the outer ring groove of the bottom of the core seat 205. The lower peripheral wall of the ring chamber wall of the spin core 151 is provided with at least two spin flow grooves 157, and the core seat chamber is communicated with the outer core chamber by the spin flow grooves 157. The lower part of the inner core chamber 150 is contracted to an inner spray opening 05; the hole wall of the inner spray opening 05 of the spin core is inserted into the outlet of the inner chamber of the core seat 205, to form an outer circular seam spray opening 005; and the hole wall of the inner spray opening 05 is uniformly distributed with small holes; the outer circular seam spray opening 005 is communicated and aligned with the inner spray opening 05 by the small holes 032. One path of pressure flow enters the outer circular seam spray opening 005 by the tangential hole 155 in the side wall of the core seat cover 154, the tangential or oblique spin flow grooves 157 in the ring chamber wall of the spin core 151 after being rotated by the ring chamber, and the other path of pressure flow is sprayed from the inner spray opening 05 by the spiral groove 159 in the inner core column 152 after being rotated by the inner core chamber 150. The spin core 151 is rotated in the same direction by setting the spin flow direction of the tangential or oblique through hole 155, the spin flow grooves and the spiral groove 159. The small holes 032 provide suspension alignment pressure for the circular seam spray hole.

### Embodiment 6

FIG. 1-6 shows a dust-proof spray nozzle p6. A subsidiary core seat 163 and a spin core 161 are arranged in a core chamber 168 of the core seat 206. A column core axle 164 of the spin core 161 uses the center hole of the reverse cup-shaped subsidiary core seat 163 as a rotary bearing hole and limits downward stopping. The reversed cup-shaped ring opening of the subsidiary core seat 163 is supported and fixed into the lower wall of the core seat 206; the bottom of the spin core 161 is provided with an expanded conical core column head 170 concentrically matched with the expanded conical outlet hole to form the conical annular slit orifice; the inlet of the annular slit is large, and the outlet is small. When not work, the core column head 170 at its inner conical large diameter is pulled by a weak elastic element 169 and then leans against the inner wall of the expanded conical outlet hole of the core seat 206, to seal the outlet hole of the core chamber so as to form a dust-proof ring surface 106, so that the annular slit spray nozzle becomes a self-closing dust-proof spray nozzle. The weak elastic element 169 is an elastic gasket/washer or spring. It is positioned between a tail fixed nut 160 of the spin core 161 and a slip ring 162, and the slip ring 162 sheathed on the core axle 164 is rotatably supported on the center hole plane of the subsidiary core seat 163, as a thrust bearing element, and the slip ring 162 can be replaced by ball or rolling bearing.

The periphery of the reversed cup-shaped ring wall of the subsidiary core seat 163 is provided with at least two tangential spin flow grooves 167; the column central section surface of the spin core 161 positioned in the flow core chamber 168 is provided with a section of twill or knurling to promote the spin flow to drive the spin core to rotate. The spin core is provided with a center hole 166; the periphery of the core column head inside the dust-proof ring surface 016 is uniformly distributed with at least four pairs of small holes 165. Fluid with pressure enters from the hole of the spray head body and then enters the spin flow core chamber 168 through the spin flow grooves 167 to rotate, and drives the spin core 161 to rotate in a floating mode, so that the pressure fluid overcomes the dust-proof weak elastic force and is rotatably extruded and sprayed from the conical circular seam spray opening. Uniform superfine spray can be obtained because of the actions of elastic vibration and spin annular slit.

### Embodiment 7

FIG. 1-7 shows another dust-proof spray nozzle, which is provided with a core seat 207; the core seat 207 is threaded and fixed in the spray head body 172; the spin core 171 is rotatably arranged in the core chamber 178 and concentric with the core chamber 178; a spin limit surface is arranged between the spin core 171 and the core chamber 178; the core chamber 178 is provided with an inlet close cover 174; the wall of the core seat 207 around the close cover 174 is provided with at least two spin flow slots 177, and the outlet hole of the core chamber is matched with the column head of the spin core 171 therein to form an annular slit orifice 007. A weak spring 173 is arranged in the center hole of the spin core 171; the top ball or stepped column with snap head 175 of the weak spring 173 is slightly butted onto the bottom of the close cover 174 to axially limit the spin core 171 capable of rotating in a floating mode, and enables the tail end surface of the core column head of the spin core 171 to lean against the outlet end surface of the core chamber, to form an externally closed dust-proof surface 017. When not in work, the outlet hole of the core chamber is sealed by the core column head via the weak elastic force of the weak spring 173 so as to prevent dust. The end wall of the spin core 171 inside the dust-proof surface 017 is symmetrically and uniformly distributed with suspension pairs of small holes 176 to help the spin core be suspended and aligned. The periphery of the spin core 171 is provided with section or two sections of discontinuous cylindrical rotary locating surfaces on which spiral grooves/teeth can be arranged. When flow with pressure enters the core chamber, spin flow dynamic pressure and suspending power can be caused, so that the spin core 171 leaves the dust-proof surface 017 and begins to rotate and performs rotary pressure spray via the circular seam spray hole 007.

### Embodiments

### 2. Spray Apparatus of the Invention

### Embodiment 1

As shown in FIG. 2-1 and FIG. 2-2, a total space spray head is provided with a spray head body 7, an inlet tube 2, and multiple spray nozzles PX, wherein the PX are spin annular slit spray nozzles of appropriate types; the spray head body 7 is provided with a spray head body chamber 6; both ends of the spray head body chamber are respectively provided with a coaxial central through hole (the upper hole is small, and the lower hole is large), and the spray head body 7 is rotatably sheathed on the steeped inlet tube 2 connected with the pressurized flow source through the central through holes; the wall of the inlet tube 2 is provided with through hole(s) or through groove(s) 11 communicated with the spray head body chamber 6, and each spray nozzle PX is arranged on the spray head body and communicated with the spray head body chamber 6; a rotary sealing element 9 is arranged between the upper central through hole 3 of the spray head body chamber 6 and the inlet tube 2, and the lower central through hole of the spray head body chamber 6 is sealed by the sealing head formed by the hollow screw-shaped core seat 208; the inner-end ring surface 245 of the sealing head becomes the upper thrust surface for the rotation of the spray head body, and the lower thrust surface for the rotation of the spray head body is a ring surface 246. The bottom of the core seat 208 is provided with a spray nozzle P8; the spray nozzle P8 is similar to the spin annular slit spray nozzle with a composite core seat p4 (see embodiment 4 for spin annular slit spray nozzle) as shown in FIG. 1-4, and is different from p4 in that the core cap 242 of P8 is arranged at the outlet end of the inlet tube 2, and is also different from p4 in that the spin core 108 of P8 is provided with an externally closed core hole 022, the periphery of the core column head 020 is uniformly distributed with at least four small alignment holes 021 communicated with the core hole 022.

The spray head body 7 is in a shape of a composite body of peripheral cross body with a truncated cone or polyhedral cone body. The periphery of the truncated cone body 5 or the polyhedral cone body is provided with spray nozzles such as P9, Pg, and Pg is a fixed spray nozzle with a spray opening. Four side surfaces in the opposite rotation direction of the four support arms of the cross body are provided with spray nozzles such as P11 or Pg, and all the end surfaces of the four support arms are provided with spray nozzles such as P7, P10. Preferably, there is an eccentric distance between the axis of P7, P10 and the axis of the spray head body. Sprayed mist of each spray nozzle on the cross body of the spray head body produces rotary driving force in the same direction to the spray head body. All spray nozzles are internally provided with spin flow passages, the spray nozzles P9, P11, and Pg are not provided with core covers and directly penetrate into the spray head body chamber 6, wherein the guide hole 8 used in the wall of the spray head body chamber and the spin flow passage 210 in the core seat 209 of the spray nozzle P9 are communicated with the spin core 109 (see FIG. 2-1A); preferably, the through holes or through grooves 11 arranged in the tube wall of the inlet tube of the spray apparatus are consonant in an oblique direction so that the spin flow generated by the through holes or through grooves in the spray head body chamber can drive the spray head body to rotate, and the rotation direction is consonant with that of the rotary driving force generated by the sprayed mist of the spray nozzle to the spray head body.

The spray head body 7 in the embodiment can be in other shape; the inlet tube 2 can be shortened to the result that the upper central through hole 3 of the spray head body chamber 6 is used as a bearing hole, and a filter 10 can be arranged in the inlet tube 2.

All the spray nozzles arranged on the spray head body 7 in the embodiment can use self-closing dust-proof spray nozzles of P7 type, and the spray head becomes dust-proof spin annular slit spray head.

### Embodiment 2

As shown in FIG. 3, a spray gun/head used for foam spraying, mainly comprises a spray head body 15, a joint 16, at least three spin annular slit spray nozzles P12 arranged on the core seat 213, and a spray gun cover 18. The core seat 213 is in threaded connection with the spray head body 15 and communicated with the pressurized flow source via the joint 16. At least three steeped round hole-shaped core chamber in which spin cores 112, 116, 115 and the like can be arranged are uniformly distributed in the core seat 213. The spin flow passage(s) capable of driving the spin core to rotate is arranged on the large column section of the spin core, and the large column section is rotatably matched with the round hole of the core chamber. The large column section can be arranged on the front section of the spin core, such as the spin core 112, or arranged on both ends of the spin core, such as the spin core 116, or arranged on the whole section of the spin core, such as the spin core 115. The spin flow passage(s) can be arranged in the chute of the large column section of the spin core, such as the spin core 116, or arranged in the spiral groove, such as the spin core 112, or arranged in the screw thread, such as the spin core 115. The diameter-shortened end column 113 of the spin core 112 exposes the core chamber hole and performs axial afterward limit near the bottom wall of the spray head body chamber 14. The diameter-shortened core column head of the spin core 112 is positioned in the diameter-shortened hole of the stepped hole of the core chamber to form the annular slit spray hole 003. The inlet gap of the annular slit spray hole 003 is larger than its outlet gap. The spray hole axes with the same axis opening of the inlet and outlet obliquely intersect on the central line of the core seat 213, and the intersection angle is 0-30°. The outlet end wall of the core seat 213 is provided with two circles of multiple suction through holes 230. The outlet of the core seat 213 is connected with the spray head cover 18. The gathered sprayed mist of each annular slit spray hole 003 flows to the funnel-shaped confluence opening for collection. The confluence opening 19 is connected with a short larynx hole 019 of the inner ring groove and the external diffusion hole 030, to form a Venturi air foam spray injection structure. The gas-water mist mixing chamber is formed by the core seat 213 and the butting chamber of the spray head cover 18, and the diffusion hole 030 is also provided with a thin foam screen additionally.

### Embodiment 3

In the above embodiment, if the spray head cover 023 is removed, and the suction through holes 230 in the outlet end wall of the core seat 213 are also removed, the spray head body is in threaded connection with the core seat 213 to form a rotor type spin annular slit spray gun or spray head; alternately, such a combined spray nozzle with multiple spin cores shown in FIG. 1-3 can be used as a spray gun or spray head as long as the seat body 135 of the spray nozzle is used as a spray head body and is connected to a pressurized flow source.

### Embodiment 4

As shown in FIG. 1-6, if the spin core 161, the core seat 206, and the subsidiary core seat 163 in embodiment 6 are used as the core seat, the spray head body, and the core seat bracket of the spray apparatus with a similar structure, and the spin core 161 is additionally provided with a small spin annular slit spray nozzle or spray nozzle of other type (not shown in the figure) communicated with the center hole 166, thus a composite spin annular slit spray head is formed; the spray head comprises a spray head body, a core seat, and a spin core; the core seat is rotatably arranged in the spray head body chamber, the core seat bracket of the spray head body chamber is provided with spin flow passage(s) and/or the peripheral wall of the core seat is provided with groove/tooth/leaf-shaped passage(s) capable of being driven to rotate by the fluid, and the core seat is driven to rotate by the spin flow of the passage(s). The outlet end of the peripheral surface at the outlet of the core seat penetrates into the outlet hole of the spray head body chamber to form the spin annular slit spray nozzle. The center and/or periphery of the spin core seat is provided with spray nozzles comprising spray nozzles with spin cores, and the spray head body chamber is communicated with the pressurized flow source and each spray nozzle. Therefore, the core seat becomes mother spin core, and the spin core arranged on the core seat becomes child spin core to form the composite spin annular slit spray head with a spin large annular slit spray nozzle in which a spray nozzle is arranged; the composite spin annular slit spray head can form a complicated composite spin spray with both revolution and spin.

Such a composite rotary spray of the spin annular slit spray nozzle/head can cause violent air agitation, intensify the friction and collision between spray drops and air, promote fine spray, greatly increase specific surface area of spray drops, favor to the complete mixing of the spray drops with air to accelerate flash evaporation of transmission media and transmission heat or accelerate the mixing and reaction with other media, thereby obviously increasing spray operation and technology efficiency.

The spray apparatus with a spin annular slit spray nozzle can be formed as long as the spin annular slit spray nozzle of the invention is arranged on the spray head body or the core seat of the spin annular slit spray nozzle is connected with the spray head body, and then the spray head body is communicated with a pressurized flow source.

The invention is described in detail in accordance with the above contents with several embodiments. However, this invention is not limited to the specific embodiments because the structures of spin core, core seat, core chamber, and spray head body are various, and the spin annular slit atomizing apparatuses combined by the spin core, the core seat, the core chamber, and the spray head are various, namely the equivalent changes and equivalent modifications which are made by using the application scope and the contents of specification of the invention should be considered to belong to the protection scope of the invention.

1. A spin annular slit spray nozzle, comprising:
a core seat;
a spin core; and
a spin annular slit orifice;
wherein
a core chamber is arranged in the core seat;
the core seat is provided with an inlet and an outlet which are communicated with the core chamber;
the inlet of the core seat is communicated with a pressurized flow source;
the spin core is limited and sheathed in the core chamber, and the spin core and the core chamber are concentric and can mutually rotate;
the wall of the spin core or the core chamber is provided with spin-actuating channel(s);
the spin core and the core chamber are mutually rotated by the spin flow power of the spin-actuating channel(s);
a core column head at the outlet end of the spin core penetrates into an outlet hole of the core chamber;
the spin annular slit orifice is formed between the core column head and the outlet hole of the core chamber;
the cross section of the spray hole approximates to a ring; and
the pressure spray fineness and flow of the spray nozzle are respectively controlled by setting a gap and diameter of the ring.

2. The spin annular slit spray nozzle of claim 1, wherein the axial shape of said spin annular slit orifice is a short and round or conical tube-shaped circular seam, and an inlet gap of the spin annular slit orifice is not less than an outlet gap thereof; the annular slit orifice close to the outlet is provided with a spray opening with the minimum annular slit gap.

3. The spin annular slit spray nozzle of claim 1, wherein said spin core is in a stepped column shape; the periphery of the spin core is provided with the spin-actuating channel(s); the ring surface of the outlet end of the spin core is contracted and connected with the small conical or small cylindrical core column head, and the ring surface of the outlet end of the spin core used as a rotary thrust limit surface is mutually rotated with the inner wall of the front end of the core chamber in a sliding mode.

4. The spin annular slit spray nozzle of claim 3, wherein said ring surface of the outlet end of the spin core is uniformly distributed with at least two sections of wedge/ring surfaces; the opening angle of the wedge surfaces is 15°, and the opening of the wedge surfaces faces the rotation direction.

5. The spin annular slit spray nozzle of claim 1, wherein said spin core is provided with a center hole which is communicated with the inlet of the core chamber and extended to the outlet end of the spin core, and the tube wall at the outlet end of said spin core is uniformly distributed with radial small holes or oblique small holes; the center hole of the spin core supplies pressure to the annular slit orifice through each small hole, to help the spin core suspend in the center and reduce friction.

6. The spin annular slit spray nozzle of claim 1, wherein the peripheral surface of said core column head or the outlet hole wall of said core chamber is provided with a short section of dense textures.

7. The spin annular slit spray nozzle of claim 1, wherein the annular slit spray opening of said spray nozzle is sealed by the outer end of the spin core to prevent dust, and the inner end of the spin core is provided with an elastic element capable of internally pulling or externally pushing the spin core, so that the conical surface or cambered surface of the outer end of the spin core leans against the outlet hole wall of the core chamber; the elastic element is an elastic washer/gasket or spring.

8. The spin annular slit spray nozzle of claim 1, wherein said core seat is of a combined type; a concentric subsidiary core seat is arranged in the core chamber of the core seat, and the disk-shaped peripheral wall of the subsidiary core seat is provided groove/tooth-shaped spin-actuating channel(s); the spin core is positioned at the center of the core chamber and the subsidiary core seat chamber, and perform rotation and axial limit by using the top center hole of the subsidiary core seat as a bearing hole; the column head of the spin core concentrically penetrates into the contracted conical outlet hole of the core seat chamber to form a reversed conical tube-shaped annular slit orifice.

9. The spin annular slit spray nozzle of claim 1, wherein said spin core is a composite spin core, and is rotatably arranged in the core seat chamber; the composite spin core is provided with an outer core chamber and a concentric inner core chamber; the inner core chamber is internally provided with an inner core element and contracted to form an inner spray hole; the wall of the inner spray hole is inserted in the center of the outlet hole of the outer core chamber, to form the spin annular slit orifice with central spray hole; and the core seat or core seat cover and the outer core chamber wall are provided with spin flow passages which are used as spin-actuating channels of the spin core.

10. The spin annular slit spray nozzle of claim 1, wherein each said spin-actuating channel is arranged on the spin core and/or the core seat; the spin-actuating channels of the spin core are oblique/spiral grooves/teeth/holes; the spin-actuating slit of the core seat are spin flow grooves/holes arranged in the core chamber wall or the core seat close cover.

11. The spin annular slit spray nozzle of claim 1, wherein both the spray fineness and the flow of said spin annular slit spray nozzle are respectively controlled; the spray drop diameter is controlled within the range of a narrow size: if an average drop diameter required by spray fineness is T, suppose the hole diameter at the minimum gap of the annular slit spray opening is D and the diameter of the core column head at the minimum clearance is d, (D−d)≦T×K, and K is the correlation coefficient of 1-3; the spray flow can be estimated by the formula Q=fΔPπDδ³/12 μL to determine the value of D and d, and the requirement of the spray flow can be met.

12. A spray apparatus, comprising: a spray head body and a spray nozzle; said spray nozzle is arranged on the spray head body; the spray head body is provided with a spray head body chamber, an inlet end of the spray head body chamber is connected with the inlet of the pressurized flow source, and an outlet end of the spray head body chamber is communicated with the spray nozzle; wherein said spray nozzle comprises a spin annular slit spray nozzle.

13. The spray apparatus of claim 12, wherein said spray head body is provided with a spray head body chamber whose end is provided with central through hole(s); the spray head body is rotatably and fixedly sheathed on a stepped inlet tube via a central through hole; the inlet tube is fixedly connected to the pressurized flow source, and the inlet tube wall is provided with through hole(s)/groove(s) communicated with the spray head body chamber; the sealing head is used for sealing the lower through hole of the spray head body chamber and performing spin thrust positioning to the spray head body, and the spray nozzle is arranged in the sealing head; the periphery of said spray head body is a combined body of a cross body and a truncated cone or polyhedral tapered body; the periphery of the spray head and four side surfaces of the cross body opposite to the rotation direction are provided with spray nozzles, and each spray nozzle is communicated with the spray head body chamber.

14. The spray apparatus of claim 12, comprising: a joint, a spray head body, a core seat, spin cores, and a spray head cover; wherein the spray head body communicating with a pressurized flow source via the joint is provided with a core seat; more than two spin core chambers are arranged in said core seat; each spin core chamber is rotatably and fixedly sheathed with a spin core to form a spin annular slit spray nozzle, and the outlets of all spray nozzles are gathered at the outlet of the core seat to spray; alternately, the outlet of the core seat is additionally provided with a Venturi tube-shaped spray head cover and the peripheral wall at the outlet of the core seat is provided with multiple suction holes; each suction hole is communicated with a mixing chamber between the outlet of the core seat and the spray head cover, and the sprayed mist of each spray nozzle is mixed with air by the mixing chamber and foamily sprayed by an outlet of the spray head cover.

15. The spray apparatus of claim 12, comprising: a spray head body, a core seat, and a spin core; wherein the core seat is rotatably arranged in the spray head body chamber; the spray head body chamber is provided with spin flow passage(s), and the core seat is driven to rotate by the spin flow of the passage(s); the outlet end of the outer peripheral surface at the outlet of the core seat penetrates into the outlet hole of the spray head body chamber to form a spin large annular slit spray nozzle; the core seat is further provided with a spray nozzle comprising a spray nozzle with a spin core; thus a composite spin annular spray head is formed, and the spray head body chamber is communicated with the pressurized flow source and each spray nozzle.

16. The spin annular slit spray nozzle of claim 2, wherein said spin core is provided with a center hole which is communicated with the inlet of the core chamber and extended to the outlet end of the spin core, and the tube wall at the outlet end of said spin core is uniformly distributed with radial small holes or oblique small holes; the center hole of the spin core supplies pressure to the annular slit orifice through each small hole, to help the spin core suspend in the center and reduce friction.

17. The spin annular slit spray nozzle of claim 3, wherein said spin core is provided with a center hole which is communicated with the inlet of the core chamber and extended to the outlet end of the spin core, and the tube wall at the outlet end of said spin core is uniformly distributed with radial small holes or oblique small holes; the center hole of the spin core supplies pressure to the annular slit orifice through each small hole, to help the spin core suspend in the center and reduce friction.

18. The spin annular slit spray nozzle of claim 4, wherein said spin core is provided with a center hole which is communicated with the inlet of the core chamber and extended to the outlet end of the spin core, and the tube wall at the outlet end of said spin core is uniformly distributed with radial small holes or oblique small holes; the center hole of the spin core supplies pressure to the annular slit orifice through each small hole, to help the spin core suspend in the center and reduce friction.

19. The spin annular slit spray nozzle of claim 2, wherein the peripheral surface of said core column head or the outlet hole wall of said core chamber is provided with a short section of dense textures.

20. The spin annular slit spray nozzle of claim 3, wherein the peripheral surface of said core column head or the outlet hole wall of said core chamber is provided with a short section of dense textures.
